(19) United States
(12) Patent Application Publication
(10) Pub. No.: US 2024/0141517 A1
(43) Pub. Date: May 2, 2024

(54) IMPROVEMENTS IN ELECTROCHEMICAL REDUCTION OF CARBON DIOXIDE

(71) Applicant: THE UNIVERSITY OF LIVERPOOL, Liverpool (GB)

(72) Inventors: Alexander J. COWAN, Liverpool (GB); Gaia NERI, Liverpool (GB); Bhavin SIRITANARATKUL, Liverpool (GB); Mark FORSTER, Liverpool (GB)

(21) Appl. No.: 18/257,699

(22) PCT Filed: Dec. 14, 2021
(86) PCT No.: PCT/GB2021/053294

§ 371 Date: Jun. 15, 2023

(30) Foreign Application Priority Data
Dec. 15, 2020 (GB) 2019826.3

(51) Int. Cl. C25B 11/032; C25B 3/26; C25B 9/23; C25B 11/095

(52) U.S. Cl. CPC C25B 11/032; C25B 3/26; C25B 9/23; C25B 11/095

(57) ABSTRACT

An electrochemical cell comprising a gas diffusion electrode for the electrochemical reduction of carbon dioxide. The gas diffusion electrode comprises a gas diffusion layer and a nickel or manganese-based molecular catalyst comprising an organic ligand. The gas diffusion electrode may provide a selective electrochemical reduction of carbon dioxide to carbon monoxide, in preference to hydrogen, and may be useful for the production of carbon monoxide from industrial waste gas streams of carbon dioxide. A nickel-based molecular catalyst and a method of electrochemical reduction of carbon dioxide are also disclosed.

### FIELD

The present invention relates to a gas diffusion electrode and a molecular catalyst for use in methods of electrochemical reduction, and to methods of electrochemical reduction of carbon dioxide using said gas diffusion electrodes. In particular, the present invention relates to manganese and nickel molecular catalysts for use in gas diffusion electrodes for electrochemical reduction of carbon dioxide preferentially to carbon monoxide.

### BACKGROUND

The electrochemical reduction of carbon dioxide has the potential to provide a useful source of chemical feedstocks, such as carbon monoxide and hydrogen, from waste gas streams containing carbon dioxide. Carbon monoxide is a versatile chemical building block which can be used in the synthesis of a variety of bulk chemicals. Therefore if carbon monoxide could be produced efficiently and selectively from a waste gas stream, such a process has the potential to reduce the environmental impact of chemical feedstock production.

Electrochemical carbon dioxide reduction on metal electrodes has been studied extensively since the 1980s, when metal electrodes were identified which were able to produce three main classes of carbon-based products when used in water. Au, Ag, Zn, Pd are known to be selective towards carbon monoxide; Sn, In, Pd, Bi produce formate; and Cu a mixture CH₄ and C₂₊ products depending on the nature of the Cu surface and the electrolyte. Since these early studies, advances have been made through the use of surface treatments, nanostructuring and alloying, but the identification of active sites is challenging which makes it difficult to tune catalytic activity.

Researchers have recently been exploring the use of metal catalysts in gas diffusion electrodes for the electrochemical reduction of carbon dioxide. In water at room temperature, the dissolved CO₂ concentration is limited to 34 mM (at room temperature and pressure) which means that CO₂, the reaction substrate, is only available at low concentrations which limits current density in conventional electrolysis cells. Gas diffusion electrodes overcome this limitation by directly delivering a CO₂ gas stream through the back of a porous electrode on which the catalyst is deposited, and which is also in contact with the electrolyte medium. For CO₂ reduction to CO, studies have focused on Au and Ag catalysts. As the catalytic activity is related to pH, with a high pH being particularly desirable as it supresses H₂ production, experiments are usually carried out around pH 13-14. This helps keep selectivity to CO₂ reduction constant even if the load is fluctuated. However, operation at very high pH has a disadvantage as the majority of the CO₂ delivered to the electrode enters the electrolyte forming carbonate salts. This means the majority of CO₂ cannot be converted and a constant decrease in pH occurs. The drop in pH decreases selectivity and can lead to electrode failure due to carbonate deposits forming.

For carbon monoxide production, a further complication is that the most active metal surfaces (Au, Ag) show a strong dependence of activity on particle size. It is commonly reported that during CO₂ electrolysis even on the <24 hr timescale that morphological changes occur with Au nanostructures and this leads to CO yields changing. This coupled with local pH fluctuations as load is varied, leads to efficiencies varying significantly under operating conditions. Furthermore it is known that common impurities found in many flue gas streams from industry (e.g. H₂S, SOₓ, NOₓ) can poison noble metal electrodes, as can common metal impurities in water feeds and support materials (e.g. from carbon supports), leading to a loss of activity. Technoeconomic analyses have suggested that CO₂ electrolysers will need to have lifetimes of at least 4000 hours to be economical to run, a value which has not yet been reached by known systems.

Therefore there remains a need for improved methods and apparatus for the electrochemical reductions of carbon dioxide to useful products.

### SUMMARY OF THE INVENTION

Molecular electrocatalysts based on transition metal centres have been widely studied for carbon dioxide reduction, particularly to CO. A particular advantage of molecular electrocatalysts is that the use of a small, designed catalytic centre that is synthetically accessible facilitates the tuning of catalytic properties. Historically, molecular catalysts have been tested when dissolved in solution (homogenous) using an inert electrode (e.g. glass carbon) and although remarkable turnover frequencies (up to 10⁶ s⁻¹) have been predicted to be achievable (through rate law analyses), they have been primarily viewed as of academic interest only. The need for many catalysts to operate in aprotic solvents coupled to the relatively low current densities and low turnover numbers have been barriers to application.

It is one aim of the present invention, amongst others, to provide a gas diffusion electrode and a molecular catalyst for use in methods of electrochemical reduction that addresses at least one disadvantage of the prior art, whether identified here or elsewhere, or to provide an alternative to existing gas diffusion electrodes. For instance it may be an aim of the present invention to provide a gas diffusion electrode and a method of electrochemical reduction of carbon dioxide which is more selective for carbon monoxide production over hydrogen production than known methods and/or more tolerant of lower pH conditions and impurities and/or having a higher activity than known electrochemical cells.

According to aspects of the present invention, there is provided a gas diffusion electrode, an electrochemical cell, a molecular catalyst for the electrochemical reduction of carbon dioxide and a method of electrochemical reduction of carbon dioxide, as set forth in the appended claims. Other features of the invention will be apparent from the dependent claims, and from the description which follows.

According to a first aspect of the present invention, there is provided an electrochemical cell comprising a cathode, an anode, an ion-exchange membrane separating the anode and cathode, and a gas supply for providing carbon dioxide gas to the cathode; wherein the cathode is provided by a gas diffusion electrode comprising a gas diffusion layer and a molecular catalyst, wherein the molecular catalyst comprises a metal and an organic ligand; wherein the metal is selected from manganese and/or nickel.

Suitably the gas diffusion layer has an electro-active side comprising the molecular catalyst and a back side, wherein the gas supply is directed to the back side of the gas diffusion layer.

Suitably the electrochemical cell comprises a catholyte at the electro-active side of the gas diffusion layer of the gas diffusion electrode. The catholyte may be provided by a source of an aqueous catholyte which is directed to the electro-active side of the gas diffusion layer of the gas diffusion electrode. Alternatively, the catholyte may be provided by a polymer catholyte arranged at the electro-active side of the gas diffusion layer of the gas diffusion electrode.

The electrochemical cell of this first aspect is suitably adapted to be used for an electrochemical reduction of a gas, suitably carbon dioxide. Therefore the gas diffusion electrode is suitably connectable to the electrochemical cell, through suitable contacts. Such arrangements of contacts are known in the art.

The electrochemical cell of this first aspect configured as described above is suitably capable of carrying out an electrochemical reaction on the incoming gas stream, suitably an electrochemical reduction of carbon dioxide to selectively form carbon monoxide over hydrogen. Suitably the electrochemical cell operates by receiving gaseous carbon dioxide and reacting said gaseous carbon dioxide with the molecular catalyst in the presence of a catholyte to produce gaseous electroreduction products, preferably a selective production of carbon monoxide.

The electrochemical cell of this first aspect is provided with a source of carbon dioxide gas, for example in a waste gas stream from an industrial process. Suitably the electrochemical cell is arranged such that the source of carbon dioxide gas is directed to the back side of the gas diffusion layer of the gas diffusion electrode. Suitably the electrochemical cell is provided with a source of an aqueous catholyte which is directed to the electro-active side of the gas diffusion layer of the gas diffusion electrode. Suitably the electrochemical cell is provided with a source of an aqueous anolyte which is directed to the anode and therefore separated from the cathode (gas diffusion electrode) and the catholyte by the ion exchange membrane. The ion exchange membrane may be either an anion exchange membrane (e.g. Fumasep) or a cation exchange membrane such as those formed of a sulfonated tetrafluoroethylene-based fluoropolymer-copolymer, for example Nafion™ 117. Alternatively, the ion-exchange membrane may be a multilayer ion-exchange membrane structure, for example a bipolar membrane comprising a cation exchange membrane and an anion exchange membrane, suitably arranged in contact with each other. Other suitable ion exchange membranes are known in the art.

The gas diffusion electrode suitably has a porous structure which allows the molecular catalyst to contact a gas, for example carbon dioxide, and a liquid electrolyte, and is electrically conductive to allow electrical current to flow through the electrode and the molecular catalyst. Alternatively, the gas diffusion electrode may be arranged in contact with a polymer membrane which is a cation or anion conductor. Such arrangements of gas diffusion electrodes are known in the art. Suitably the gas diffusion electrode is adapted so that a gas can be introduced on one side of the gas diffusion electrode and an electrolyte can be introduced on the opposite side of the gas diffusion electrode wherein the gas and the electrolyte can interact with the molecular catalyst to provide an electrochemical reaction of the gas.

In some embodiments, the electrochemical cell of this first aspect is arranged as a “zero-gap” electrochemical cell. Such a zero-gap electrochemical cell involves arranging the molecular catalyst of the gas diffusion electrode in direct contact with the ion-exchange membrane. In such embodiments, the ion-exchange membrane is suitably a bipolar membrane (BPM) comprising a cation-exchange membrane (CEM) and an anion-exchange membrane (AEM). The molecular catalyst of the gas diffusion electrode may be arranged in direct contact with the CEM or the AEM of the BPM. Suitably the molecular catalyst is arranged in direct contact with CEM. The AEM is suitably arranged in direct contact with the anode of the electrochemical cell.

Therefore in such zero-gap electrochemical cells, no liquid electrolyte (catholyte) is present between the cathode and the ion-exchange membrane(s) and suitably no liquid electrolyte (anolyte) is present between the anode and the ion-exchange membrane(s). In such embodiments, the catholyte is a polymer catholyte, i.e. is provided by the cation-exchange membrane or the anion-exchange membrane, suitably by the cation-exchange membrane.

Suitably the zero-gap electrochemical cell is arranged to receive CO₂ at the cathode (as described above) and to receive water at the anode. Suitably in operation, hydrated CO₂ is flowed to the cathode and deionized H₂O or an aqueous electrolyte is flowed to the anode.

The configuration of the zero-gap electrochemical cell described above creates a low pH (acidic) local environment at the cathode and a relatively high pH (alkaline) environment at the anode, which may be beneficial for the selectivity of the electrochemical reduction of CO₂ to CO and the longevity of the electrochemical cell.

The gas diffusion electrode of the electrochemical cell of this first aspect comprising the molecular catalyst is suitable for the electrochemical reduction of carbon dioxide. The inventors have found that such a gas diffusion electrode comprising the molecular catalyst, such as those described herein, can effectively and efficiently provide an electrochemical reduction of carbon dioxide to carbon monoxide which is highly selective for carbon monoxide production over hydrogen production. Specifically, this selective carbon monoxide production may be obtained even at low pH conditions which would be expected to favour hydrogen production over carbon monoxide production based on known electrochemical reduction methods. This favourable selectivity may be particularly useful in industrial applications where waste gas streams of carbon dioxide also contain acidic species which are therefore difficult to process into carbon monoxide without producing large amounts of hydrogen. Also, the inventors believe that the gas diffusion electrodes of the present invention may be more tolerant to impurities in such waste gas streams of carbon dioxide and may therefore be more effective in processing such impure carbon dioxide streams into carbon monoxide. The gas diffusion electrodes of the present invention may therefore have a higher activity and a longer effective catalyst lifetime in order to make the electrochemical reduction process economically feasible and beneficial. The gas diffusion electrodes and molecular catalysts of the present invention may therefore allow the electrochemical reduction of carbon dioxide from waste gas streams to carbon monoxide to be implemented on an industrial scale in order to efficiently provide this useful chemical feedstock and displace other more energy intensive and polluting methods of carbon monoxide production whilst preventing a proportion of the carbon dioxide from the waste gas stream from reaching the atmosphere and contributing to climate change. The present invention may therefore provide a significant economic and environmental benefit.

The gas diffusion electrode of the electrochemical cell of this first aspect comprises a gas diffusion layer and a molecular catalyst. The gas diffusion layer may be any suitable porous material which can function as described above to allow a sufficient interaction of an incoming gas stream, an electrolyte and the molecular catalyst. The gas diffusion layer may be a porous carbon material. For example, a suitable porous carbon material may be a fibrous carbon cloth or a carbon paper. Such a suitable carbon paper is a hydrophobic material which has a microporous carbon layer deposited on the catalyst side to increase the effective surface area. Suitably the gas diffusion layer is hydrophobic and therefore allows limited penetration of an aqueous electrolyte into the pores of the material. Suitably the molecular catalyst is retained on the gas diffusion layer, suitably on one side of the gas diffusion layer, suitably the side which is to contact the electrolyte in use. This side of the gas diffusion layer comprising the molecular catalyst may be referred to as the electro-active side and the other side of the gas diffusion layer may be referred to as the back side. Suitably the molecular catalyst is arranged on the gas diffusion layer on the electro-active side so that in use the incoming gas stream has to penetrate the pores of the gas diffusion layer from the back side to reach the molecular catalyst.

The molecular catalyst is suitably retained on the gas diffusion layer, for example through non-covalent interactions between the molecular catalyst and the gas diffusion layer. Suitably the molecular catalyst is adhered to the gas diffusion layer, for example with a binder polymer. Suitably the molecular catalyst is adhered to the gas diffusion layer through such non-covalent interactions and through such a binder polymer. A suitable binder polymer may be a fluorocarbon polymer, for example PTFE and/or a sulfonated tetrafluoroethylene-based fluoropolymer-copolymer, for example Nafion™. The molecular catalyst may be deposited and adhered to the gas diffusion layer using a catalyst ink comprising the molecular catalyst, a binder polymer and a solvent. The catalyst ink may be sprayed onto the gas diffusion electrode and dried, suitably in ambient conditions. The inventors have found that this arrangement can provide a robust gas diffusion electrode where the catalyst is retained on the gas diffusion layer throughout many operational cycles.

The back side of the gas diffusion layer may be treated with a hydrophobic polymer, for example a fluorocarbon polymer such as PTFE. This may help prevent flooding of the pores of the gas diffusion layer with electrolyte solution in use, which can adversely affect the performance of the gas diffusion electrode.

The molecular catalyst of the gas diffusion electrode comprises a metal and an organic ligand. The term molecular catalyst is used to denote a catalyst species which is a molecule or complex and is therefore distinct from simple metal catalysts. A molecular catalyst may be generally described as a transition metal complex comprising one or more ligands and having a defined and finite molecular structure. Counterions may also be present in the molecular catalyst. The molecular catalyst may consist essentially of the metal, the organic ligand and counterions, when present. The molecular catalyst may also be referred to as a complex of the metal and the organic ligand (and any counterions present). The molecular catalyst may also contain solvent molecules functioning as ligands, for example through solvent exchange with a counterion of the molecular catalyst. The metal is selected from manganese and/or nickel. The inventors have found that a range of related nickel and manganese catalysts may be particularly effective in the gas diffusion electrodes for use in the electrochemical cell of this first aspect for the electrochemical reduction of carbon dioxide to carbon monoxide.

Suitably the organic ligand is a nitrogen-containing heterocycle. Suitably the organic ligand is a nitrogen-containing heterocyclic ligand. Suitably the ligand is a bidentate ligand or a poly-dentate ligand. For example, the organic ligand may be a bipyridyl ligand or an azamacrocycle, for example a cyclam.

Suitably the molecular catalyst has a formula which comprises MLₐX_{b}, wherein M is the metal selected from manganese and nickel, L is the organic ligand and X is an anion, wherein a is an integer from 1 to 3 and b is an integer from 0 to 4. Suitable anions may be selected from halogens, perchlorates and PF₆_{^{−}}. Suitably a is 1. Suitably b is an integer from 0 to 2.

In some embodiments the molecular catalyst also comprises CO ligands. In such embodiments the molecular catalyst has the formula M(L)(CO)_{c}X_{b}, wherein L is the organic ligand and X is an anion, wherein c is an integer from 1 to 4 and b is an integer from 0 to 4. Suitably b is an integer from 0 to 2.

In some embodiments the molecular catalyst is a manganese molecular catalyst comprising at least one nitrogen-containing heterocycle. In such embodiments the manganese molecular catalyst has the formula Mn(L)(CO)_{c}X_{b}, wherein L is a nitrogen-containing heterocycle and X is an anion; wherein c is an integer from 1 to 4 and b is an integer from 0 to 4.

In embodiments wherein the organic ligand is a bipyridyl ligand, the ligand suitably has the formula (I):

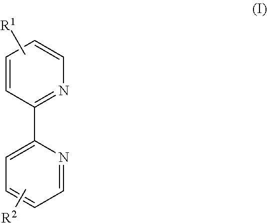

wherein R¹ and R² are each independently selected from H, hydroxy, amino, thiol, chloro, fluoro, CF₃, CHF₂, CH₂F, a C₁-C₈ alkyl group, optionally forming a ring, a C₁-C₈ alkenyl group, an aryl group, a heteroaryl group, a C₁-C₈ alkoxy group, a C₁-C₈ alkylamino group, a C₁-C₈ alkylthio group, groups; or a (CO)OR³ group or a (CO)NHR³ group, wherein R³ is selected from H, a C₁-C₈ alkyl group, optionally forming a ring, a C₁-C₈ alkenyl group or an aryl group.

Suitably R¹ and R² are each independently selected from H, a C₁-C₆ alkyl group, optionally forming a ring, a C₁-C₆ alkenyl group, an aryl group, a (CO)OR³ group or a (CO)NHR³ group.

Suitably the nitrogen-containing heterocycle is a 2,2′-bipyridyl ligand, suitably having the formula (II):

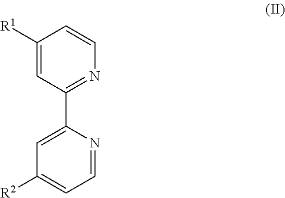

wherein R¹ and R² are as defined above.

Suitably the bipyridyl ligand is selected from formulas (III)-(VII):

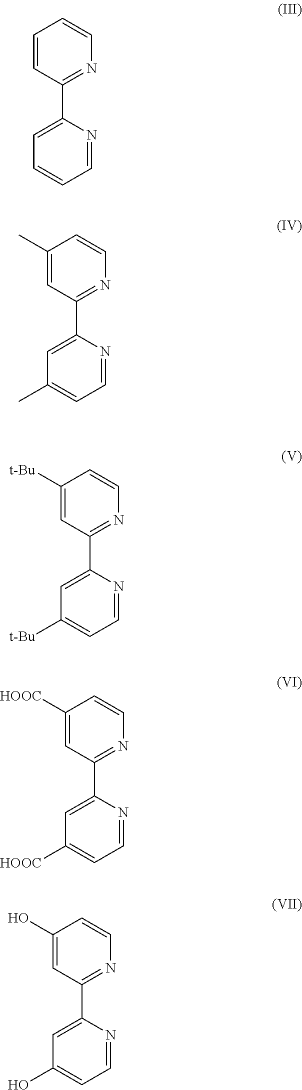 [SMILES: c1ccc(-c2ccccn2)nc1 ; Cc1ccnc(-c2cc(C)ccn2)c1 ; CC(C)(C)c1ccnc(-c2cc(C(C)(C)C)ccn2)c1 ; O=C(O)c1ccnc(-c2cc(C(=O)O)ccn2)c1 ; Oc1ccnc(-c2cc(O)ccn2)c1]

In such embodiments wherein the organic ligand of the molecular catalyst is a bipyridyl ligand as described above, the metal is suitably manganese. In such embodiments the manganese molecular catalyst has the formula Mn(L)(CO)_{c}X_{b}, wherein L is the bipyridyl ligand as described above and X is an anion; wherein c is an integer from 1 to 4 and b is an integer from 0 to 4.

Suitably the manganese molecular catalyst is selected from complexes 1 to 4 and 9:

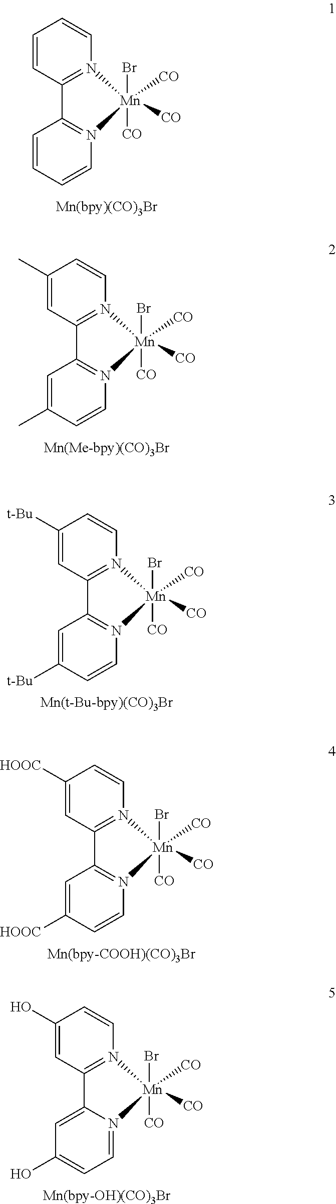

In some embodiments wherein the organic ligand is an azamacrocycle ligand, the ligand may comprise a polyaromatic group tethered to the azamacrocycle to assist with adhering the molecular catalyst to the gas diffusion layer, as discussed below.

In some embodiments, the ligand does not comprise such a polyaromatic group. In such embodiments the ligand is suitably a cyclam, suitably having the formula (VIII):

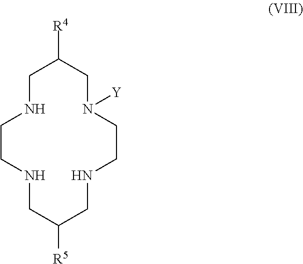

wherein R⁴ and R⁵ are each independently selected from H, hydroxy, amino, thiol, chloro, fluoro, CF₃, CHF₂, CH₂F, a C₁-C₈ alkyl group, optionally forming a ring, a C₁-C₈ alkenyl group, an aryl group, a heteroaryl group, a C₁-C₈ alkoxy group, a C₁-C₈ alkylamino group, a C₁-C₈ alkylthio group, groups; or a (CO)OR⁶ group or a (CO)NHR⁶ group, wherein R⁶ is selected from H, a C₁-C₈ alkyl group, optionally forming a ring, a C₁-C₈ alkenyl group or an aryl group;
wherein Y is selected from H, a (CH₂)ₙZ group, wherein n is an integer from 1 to 6 and Z is a polar group selected from —PO₃H₂, —CO₂H, —Si(OH)₃, —SH, NH₂ and OH.

Suitably R⁴ is as defined above and R⁵ is H.

Suitably R⁴ is H, a (CO)OR⁶ group as defined above, —NH₂, phenol or OH and R⁵ is H. Suitably R⁴ is H or a (CO)OR⁶ group as defined above and R⁵ is H.

Suitably n is 1 or 2, suitably 1.

Suitably the cyclam ligand is selected from formulas (IX)-(XI):

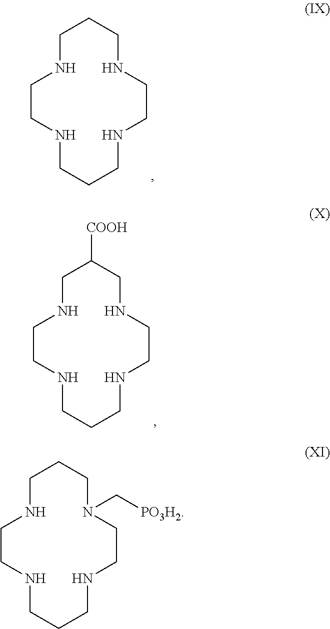

In such embodiments wherein the organic ligand of the molecular catalyst is a cyclam ligand as described above, the metal is suitably nickel. Therefore the molecular catalyst is suitably a nickel molecular catalyst comprising an azamacrocycle having/comprising the formula (XII):

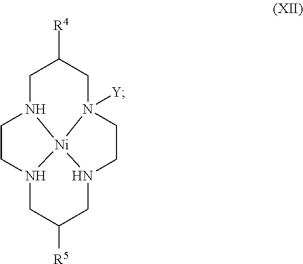

wherein R⁴, R⁵ and Y are as defined above.

Suitably the complexes described herein are neutral and may comprise counterions, such as a halogens ion, e.g. chloride, to balance the charge of the metal and/or ligand. For example, nickel suitably has a charge of 2+ and therefore the nickel complexes suitably comprise counterions with an overall 2− charge, such as two chloride ions. If the organic ligand has a negative charge then the nickel complex suitably comprises counterions with a 1− charge, such as one chloride ion.

Suitably the nickel molecular catalyst is selected from complexes 5 to 7:

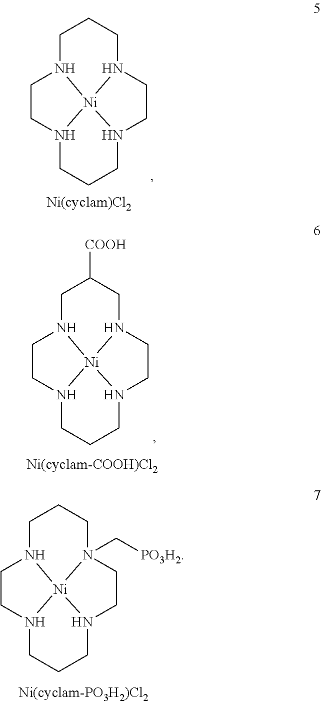

In some embodiments, the ligand does comprise such a polyaromatic group. In such embodiments the ligand is suitably a cyclam, suitably having the formula (VIII):

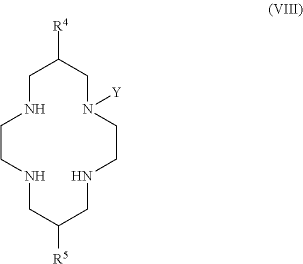

wherein R⁴ and R⁵ are each independently selected from H, hydroxy, amino, thiol, chloro, fluoro, CF₃, CHF₂, CH₂F, a C₁-C₈ alkyl group, optionally forming a ring, a C₁-C₈ alkenyl group, an aryl group, a heteroaryl group, a C₁-C₈ alkoxy group, a C₁-C₈ alkylamino group, a C₁-C₈ alkylthio group, groups; or a (CO)OR⁶ group or a (CO)NHR⁶ group, wherein R⁶ is selected from H, a C₁-C₈ alkyl group, optionally forming a ring, a C₁-C₈ alkenyl group or an aryl group;
wherein Y is a (CH₂)ₘAr group, wherein m is an integer from 1 to 6 and Ar is a polyaromatic hydrocarbyl group.

Suitably R⁴ is as defined above and R⁵ is H.

Suitably R⁴ is H, a (CO)OR⁶ group as defined above, —NH₂, phenol or OH and R⁵ is H. Suitably R⁴ is H ora (CO)OR⁶ group as defined above and R⁵ is H.

Suitably m is an integer from 1 to 4.

Suitably the polyaromatic hydrocarbyl group Ar is selected from naphthalene, anthracene, phenanthrene, pyrene, benzopyrene or coronene.

Suitably the cyclam ligand has the formula (XIII):

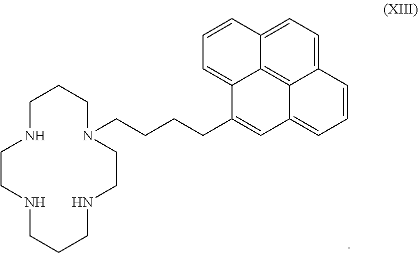 [SMILES: c1cc2ccc3cccc4c(CCCCN5CCCNCCNCCCNCC5)cc(c1)c2c34]

In such embodiments wherein the organic ligand of the molecular catalyst is a cyclam ligand as described above, the metal is suitably nickel. Therefore the molecular catalyst is suitably a nickel molecular catalyst comprising an azamacrocycle having the formula (XII):

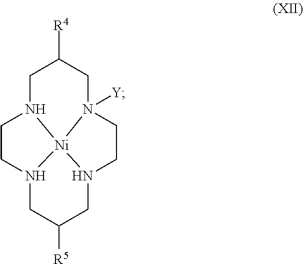

wherein R⁴, R⁵ and Y are as defined above.

In some embodiments the nickel molecular catalyst has the formula [Ni(1,4,8,11-tetraazacyclotetradecane-1-R¹-R²)] wherein R¹ is a hydrocarbyl group having from 1 to 6 carbon atoms and R² is an optionally substituted aromatic hydrocarbyl group, for example complex 8:

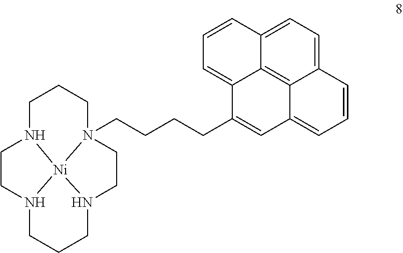

According to a second aspect of the present invention, there is provided a gas diffusion electrode comprising a gas diffusion layer and a molecular catalyst, wherein the molecular catalyst is:

a manganese molecular catalyst having the formula Mn(L)(CO)_{c}X_{b}, wherein L is a nitrogen-containing heterocycle and X is an anion; wherein c is an integer from 1 to 4 and b is an integer from 0 to 4; or
a nickel molecular catalyst having the formula (XII):

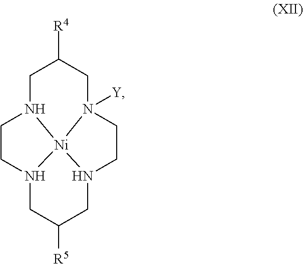

wherein R⁴ and R⁵ are each independently selected from H, hydroxy, amino, thiol, chloro, fluoro, CF₃, CHF₂, CH₂F, a C₁-C₈ alkyl group, optionally forming a ring, a C₁-C₈ alkenyl group, an aryl group, a heteroaryl group, a C₁-C₈ alkoxy group, a C₁-C₈ alkylamino group, a C₁-C₈ alkylthio group, groups; or a (CO)OR⁶ group or a (CO)NHR⁶ group, wherein R⁶ is selected from H, a C₁-C₈ alkyl group, optionally forming a ring, a C₁-C₈ alkenyl group or an aryl group;
wherein Y is selected from H, a (CH₂)ₙZ group, wherein n is an integer from 1 to 6 and Z is a polar group selected from —PO₃H₂, —CO₂H, —Si(OH)₃, —SH, NH₂ and OH.

The gas diffusion electrode of this second aspect is suitably adapted to be used as an electrode in an electrochemical cell for an electrochemical reduction of a gas, suitably carbon dioxide, as described in relation to the first aspect. Therefore the gas diffusion electrode is suitably connectable to such an electrochemical cell, through suitable contacts. Such arrangements of contacts are known in the art. Suitably the gas diffusion electrode of this first aspect provides the cathode of such an electrochemical cell.

The gas diffusion electrode of this second aspect suitably has any of the suitable features and advantages described in relation to the first aspect.

According to a third aspect of the present invention, there is provided a molecular catalyst having the formula (XII):

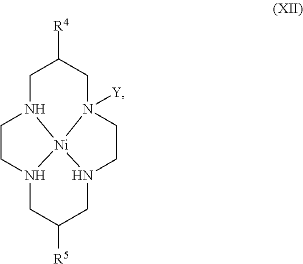

wherein R⁴ and R⁵ are each independently selected from H, hydroxy, amino, thiol, chloro, fluoro, CF₃, CHF₂, CH₂F, a C₁-C₈ alkyl group, optionally forming a ring, a C₁-C₈ alkenyl group, an aryl group, a heteroaryl group, a C₁-C₈ alkoxy group, a C₁-C₈ alkylamino group, a C₁-C₈ alkylthio group, groups; or a (CO)OR⁶ group or a (CO)NHR⁶ group, wherein R⁶ is selected from H, a C₁-C₈ alkyl group, optionally forming a ring, a C₁-C₈ alkenyl group or an aryl group;
wherein Y is a (CH₂)ₘAr group, wherein m is an integer from 1 to 6 and Ar is a polyaromatic hydrocarbyl group.

Suitably R⁴ is as defined above and R⁵ is H.

Suitably R⁴ is H or a (CO)OR⁶ group as defined above and R⁵ is H.

Suitably m is an integer from 1 to 4.

Suitably the polyaromatic hydrocarbyl group Ar is selected from naphthalene, anthracene, phenanthrene, pyrene, benzopyrene or coronene.

Suitably R⁴ and R⁵ are H, m is an integer from 1 to 4 and Ar is selected from naphthalene, anthracene, phenanthrene, pyrene, benzopyrene or coronene.

In one embodiment, the molecular catalyst is complex 8:

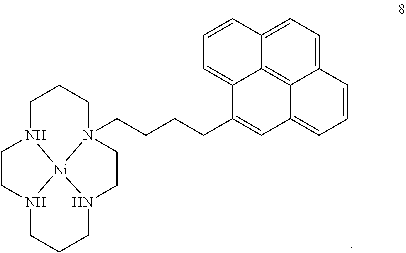

A limitation of molecular catalyst GDEs can be that catalysts are prone to be removed if the electrode is rinsed/washed. The polyaromatic hydrocarbyl group Ar is included in the molecular catalyst to improve the binding of the molecular catalyst to the gas diffusion layer in order to achieve longer-term activity of the molecular catalyst in the gas diffusion electrode. In particular, it is believed that the pyrene group of complex 8 can form a strong π-π interaction with the sp² carbon gas diffusion layer and has been shown to resist washing off, for example when it is desired to wash out salts which have accumulated in the gas diffusion electrode to prolong the active lifetime of the gas diffusion electrode.

According to a fourth aspect of the present invention, there is provided a method of electrochemical reduction of carbon dioxide, the method comprising:
a) providing a cathode and an anode, wherein the cathode is a gas diffusion electrode comprising a molecular catalyst, wherein the molecular catalyst comprises a metal and an organic ligand; wherein the metal is selected from manganese and/or nickel;
b) contacting the carbon dioxide in gaseous form with the molecular catalyst, optionally in the presence of water; and
c) applying an electrical potential between the cathode and the anode, thereby electrochemically reducing the carbon dioxide to gaseous products including carbon monoxide.

Suitably the gas diffusion electrode provided in step a) is a gas diffusion electrode according to the second aspect, therefore having a gas diffusion layer with an electro-active side comprising the molecular catalyst and a back side. The method may be carried out using an electrochemical cell according to the first aspect.

Step involves b) contacting the carbon dioxide in gaseous form with the molecular catalyst, optionally in the presence of water. Therefore step b) does not involve a source of carbon dioxide which is dissolved in a solution or electrolyte. The method of this fourth aspect is a method of gas diffusion electrolysis which involves directly delivering carbon dioxide gas through the back side of the gas diffusion electrode on which the molecular catalyst is deposited, and which is also in contact with an electrolyte medium.

Step b) suitably involves delivering carbon dioxide, for example as part of a waste gas stream from an industrial process, to the back side of the gas diffusion layer in the cathode, suitably penetrating into the gas diffusion layer. Suitably a catholyte is simultaneously provided to the electro-active side of the gas diffusion layer in the cathode. Suitably step b) also involves providing an anolyte to the anode, wherein the anolyte and the catholyte are separated by an ion exchange membrane as described in relation to the first aspect.

In some embodiments, step b) may be carried out at an alkaline pH. In such embodiments the pH of the catholyte is suitably at least 10, suitably at least 12, suitably at least 14 or approximately 14.

In some embodiments, step b) may be carried out at an acidic pH. In such embodiments the pH of the catholyte is suitably up to 6, suitably up to 4, suitably up to 3, for example up to 2 or approximately 2. Suitably steps b) and c) take place at a pH of less than 6.

The electrical potential applied in step c) depends on the scale of the apparatus on which the method is carried out and can be arrived at by using common knowledge in this field in light of the teachings herein.

The method suitably involves a step e) of collecting the gaseous products. Suitable methods for collecting and storing the gaseous products are known in the art. For example, the gaseous products may be dried, optionally purified and bottled.

Suitably steps b) and c) of the method provide a conversion efficiency of carbon dioxide to carbon monoxide of at least 10%, suitably at least 20% or at least 40%, suitably at least 60%.

In some embodiments the gaseous products including carbon monoxide produced in step c) are recirculated to the gas diffusion electrode comprising the molecular catalyst to undergo further electrochemical reduction of the carbon dioxide remaining in the gaseous products of step c). Therefore the method may be considered to comprise a step d) of recirculating the gaseous products including carbon monoxide produced in step c) to the gas diffusion electrode. Such recirculation may be continued until the concentration of the carbon monoxide in the gaseous products mixture raises to a desired threshold, for example at least 20%, suitably at least 40%, at least 60% or at least 80%.

Suitably the method of this fourth aspect selectively produces carbon monoxide over other products of electrochemical reduction of carbon dioxide, over hydrogen in particular. Therefore the method of this fourth aspect may be considered to be a method of selective electrochemical reduction of carbon dioxide to carbon monoxide, suitably a method of electrochemical reduction of carbon dioxide selectively to carbon monoxide over hydrogen. The gaseous products produced in step c) and collected in step e) may therefore be enriched in carbon monoxide, suitably compared to hydrogen and unreacted carbon dioxide.

This fourth aspect therefore suitably provides a selective method of producing carbon monoxide from the electrochemical reduction of carbon dioxide which can advantageously be carried out at a relatively high or a relatively low pH and may therefore provide an efficient industrial scale process for obtaining this useful chemical building block from different industrial waste gas streams.

### EXAMPLES

The following experiments were conducted on a laboratory scale to investigate the feasibility of using on a larger scale the above-described gas diffusion electrode, electrochemical cell, molecular catalyst and method for the selective electrochemical reduction of carbon dioxide to carbon monoxide.

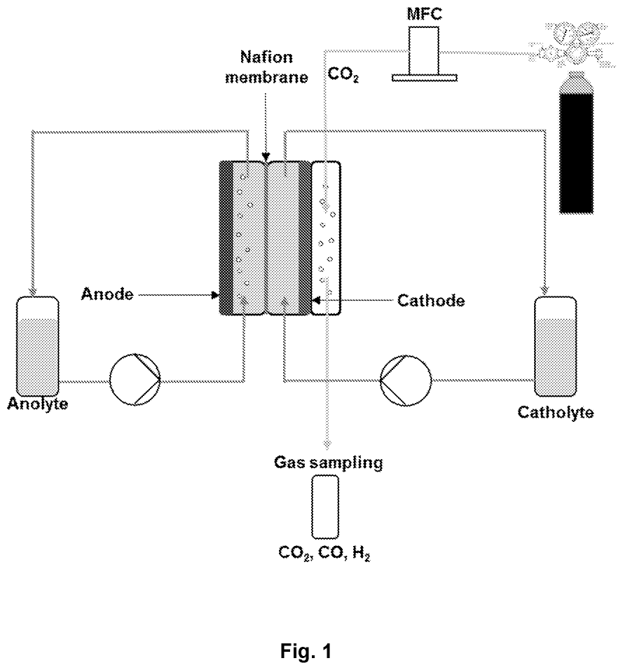

A scheme of the set-up used for all experiments is shown in FIG. 1. The electrochemical cell used was a Microflow cell supplied by Electrocell. This is a modular cell in which all of the components are in a stacked array and includes rubber gaskets providing a seal and PTFE spacers for the electrolyte reservoir and gas delivery. This cell allows testing in a two or three electrode set-up.

A platinised Ti plate anode was used, while the working gas diffusion electrode (area: 10 cm²) was mounted on a Ti plate to provide electrical contact. The reference electrode was either a commercial leakless Ag/AgCl, supplied with the cell, or a pyrrole electrode on stainless steel.

Unless stated otherwise, all potentials are reported for the cathode only (half-cell) and are versus Ag/AgCl. An ion exchange membrane was sandwiched between the electrodes to separate the anode and cathode chambers. Unless otherwise specified, the membrane used for the experiments was Nafion™ 117, which was cut to shape and pre-activated by boiling in deionised water for two hours prior to the first use, and stored in deionised water when not in use.

The cell was connected to two electrolyte reservoirs, and the electrolyte was supplied separately to the anode and cathode by two peristaltic pumps with a flow of 7.5 ml min⁻¹. This allowed for the use of two different electrolytes. The gas (CO₂ or Ar) was supplied via either a mass flow controller or variable flow meters, which allowed for the variation of the gas flow. Another flow meter was connected on the outlet in order to monitor the gas flow and a custom-made gas sampling chamber was mounted to allow GC measurements. All connections were either stainless steel Swagelok or PTFE fittings in order to ensure maximum gas tightness.

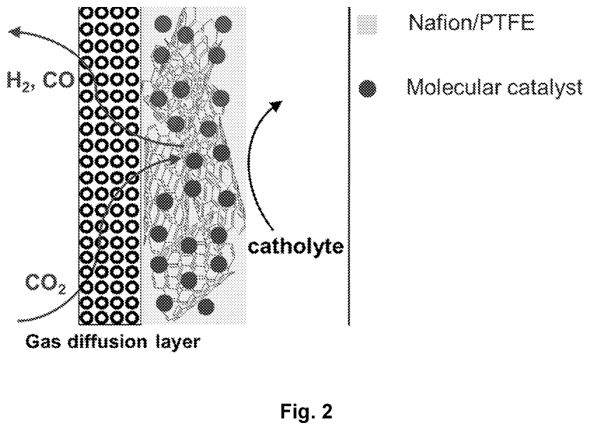

A scheme of the gas diffusion electrode is shown in FIG. 2. The electrode was made of a gas diffusion layer, a hydrophobic fibrous carbon cloth or paper (cut to the shape of the Ti mask) on which the catalyst ink was deposited.

A range of gas diffusion electrodes were studied (ELAT1400, CeTECH, ELATHydro, AvCarb and Sigracet 29 BC) and unless stated otherwise, experiments are reported with samples prepared on Elat 1400.

Catalyst inks for deposition were prepared by mixing a solution of the catalyst (0.2 mmol) in the appropriate solvent (350 μl of MeCN or ethanol) and Nafion™ 5% solution in alcohols (150 μl) with variable amounts of a 1% PTFE suspension in water. Initial results reported (apart from the pH study of complex 6) also had MWCNT (multi-walled carbon nanotubes) added to the suspension in a 1:1 wt ratio (to the catalyst).

The prepared catalyst ink was loaded onto a 2 ml solvent reservoir of an airbrush gun (Harder & Steenbeck Evolution CRplus 0.15 mm Airbrush) and sprayed at room temperature over the active area of the pre-cut gas diffusion layer (GDL). The electrodes were left to dry in air. Some samples were found to show electrode flooding. Experiments to address flooding also explored the use of PTFE (1% in water) deposited onto the rear (gas side) of the GDE assembly.

The potentiostat had a current limit meaning measurements and so only a small potential window is initially addressed. Gas samples were collected periodically from the exhaust and sampled by GC using a 5 Å molecular sieve column and PDD detector.

The following catalyst examples were prepared using previously reported synthetic methods:
1: [Mn(bpy)(CO)₃Br]—synthesis described in M. Bourrez, F. Molton, S. Chardon-Noblat and A. Deronzier, Angew. Chem. Int. Ed. Engl., 2011, 50, 9903-9906.
2: [Mn(Me-bpy)(CO)₃Br] where Me-bpy=4,4′-di-methyl-2,2′bipyridine—synthesis described in M. Bourrez, M. Orio, F. Molton, H. Vezin, C. Duboc, A. Deronzier and S. Chardon-Noblat, Angew. Chem. Int. Ed. Engl., 2014, 53, 240-243.
3: [Mn(t-bu-bpy)(CO)₃Br] where tbu-bpy=4,4′-di-tert-butyl-2,2′bipyridine—synthesis described in J. J. Walsh, C. L. Smith, G. Neri, G. F. S. Whitehead, C. M. Robertson and A. J. Cowan, Faraday Discuss., 2015, 183, 147-160.
4: [Mn(COOH-bpy)(CO)₃Br] where COOH-bpy=4,4′-di-carboxylic acid-2,2′bipyridine—synthesis described in J. J. Walsh, C. L. Smith, G. Neri, G. F. S. Whitehead, C. M. Robertson and A. J. Cowan, Faraday Discuss., 2015, 183, 147-160.
5: [Ni(cyclam)Cl₂] where cyclam=1,4,8,11-tetraazacyclotetradecane—synthesis described in M. Beley, J.-P. Collin, R. Ruppert and J.-P. Sauvage, J. Chem. Soc. Chem. Commun., 1984, 1315-1316.
6: [Ni(cyclam-CO₂H)Cl₂] where cyclam-CO₂H=1,4,8,11-tetraazacyclotetradecane-6-carboxylic acid)—synthesis described in G. Neri, I. M. Aldous, J. J. Walsh, L. J. Hardwick and A. J. Cowan, Chem. Sci., 2016, 7, 1521-1526.
7: [Ni(cyclam-PO₃H₂)Cl] where cyclam-PO₃H₂=[(1,4,8,11-tetraazacyclotetradecan-1-yl)methyl]phosphonic acid—synthesis described in G. Neri, M. Forster, J. J. Walsh, C. M. Robertson, T. J. Whittles, P. Farras and A. J. Cowan Chem. Commun., 2016, 52, 14200-14203.
A new catalyst 8: ([Ni(cyclam-py)] where cyclam-py=1,4,8,11-tetraazacyclotetradecane-1-butyl-pyrene) was prepared as described separately below.
9: [Mn(bpy-OH)(CO)₃Br] where bpy-OH=4,4′-di-hydroxy-2,2′bipyridine—synthesis described in James J Walsh, Charlotte L Smith, Gaia Neri, George F S Whitehead, Craig M Robertson, Alexander J Cowan, Faraday Discuss., 2015, 183,147-60.

### Synthesis of Catalyst 8

Synthesis of 4-(pyren-1-yl)butanal (8.1): To a solution of 1-pyrenebutanol (1.2 g, 4.3 mmol) in dry DCM (15 ml) under an inert atmosphere, a suspension of pyridinium dichromate (2.5 mg, 6.65 mmol) in dry DCM (15 ml) was added rapidly. The resulting suspension was stirred under argon overnight. The suspension was then diluted with 600 ml of diethyl ether and washed with water first followed by brine twice. The organic phase was dried over MgSO₄, then filtered and the solvent was evaporated. The resulting orange oil was purified using a silica plug eluted with chloroform. Yellow oil obtained: 900 mg, yield: 75%.

¹H NMR (400 MHz, CDCl₃): δ 9.75 (s, 1H), 8.25 (d, J=9.3 Hz, 1H), 8.18 (dd, J=7.6, 2.0 Hz, 2H), 8.10 (dd, J=8.5, 4.4 Hz, 2H), 8.03 (s, 2H), 8.02-7.99 (m, 1H), 7.80 (d, J=7.8 Hz, 1H), 3.35-3.27 (m, 2H), 2.49 (td, J=7.2, 1.6 Hz, 2H), 2.15 (p, J=7.3 Hz, 2H). ¹³C NMR (101 MHz, CDCl₃): δ 200.99, 130.25, 129.71, 128.84, 127.53, 126.32, 126.28, 126.07, 125.60, 124.72, 123.92, 123.82, 123.81, 123.67, 123.65, 122.03, 42.20, 31.33, 22.71.

Synthesis of tri-tert-butyl 11-(4-(pyren-1-yl)butyl)-1,4,8,11-tetraazacyclotetradecane-1,4,8-tricarboxylate (8.2): 976 mg of Boc₃cyclam (1.95 mmol), and 800 mg of 8.1 (2.9 mmol) were added to a round bottom flask containing 4 Å activated molecular sieves under argon and dissolved in dry DCE (20 ml). The solution was stirred for 2 hours under argon at room temperature. Sodium triacetoxyborohydride (827 mg, 3.9 mmol) was added under an Ar blanket and the solution was stirred for 24 hours. The crude solution was washed with three aliquots of 2 M NaHCO₃ then the organic fraction was dried over MgSO₄, filtered and the solvent was evaporated to yield a yellow oil. The product was isolated by flash column chromatography, eluting first with DCM then with DCM:EtOAc 50:50. Yellow foam obtained: 1.16 g, yield: 83%.

¹H NMR (400 MHz, CDCl₃): δ 8.25 (d, J=9.3 Hz, 1H), 8.15 (ddd, J=7.9, 3.8, 1.3 Hz, 2H), 8.10 (dd, J=8.5, 3.2 Hz, 2H), 8.01 (d, J=2.2 Hz, 2H), 7.98 (d, J=7.6 Hz, 1 H), 7.84 (d, J=7.8 Hz, 1H), 3.33 (t, J=7.8 Hz, 7H), 3.26 (s, 7H), 2.55 (s, 2H), 2.41 (t, J=7.6 Hz, 4H), 1.81 (q, J=7.6 Hz, 4H), 1.72 (p, J=7.3 Hz, 2H), 1.61 (s, 4H), 1.45 (d, J=4.5 Hz, 27H). ¹³C NMR (101 MHz, CDCl₃): δ, 155.65, 136.76, 131.40, 130.88, 129.76, 128.54, 127.50, 127.22, 127.17, 126.54, 125.79, 125.06, 125.00, 124.83, 124.79, 124.65, 123.37, 79.47, 79.30, 55.38, 53.47, 51.46, 46.87, 45.70, 33.49, 29.80, 28.53, 28.48, 26.75.

Synthesis of 1-(4-(pyren-1-yl)butyl)-1,4,8,11-tetraazacyclotetradecane (8.3): 1.16 g of 8.2 (1.53 mmol) was dissolved in 15 ml of DCM, then 7.5 ml of TFA was added dropwise at room temperature. The solution was stirred at room temperature until no change was detected in the TLC (DCM:EtOAC 50:50), ca. 6 hours. The solvent was rotary evaporated (MeOH was continually added to aid with complete TFA removal). The crude was purified by passing through an Amberlite IRN-78 twice, eluting with MeOH. Yellow oil obtained: 620 mg, yield 83%.

¹H NMR (400 MHz, CDCl₃): δ 8.24 (d, J=9.3 Hz, 1H), 8.13-8.02 (m, 4H), 7.98-7.89 (m, 3H), 3.30 (t, J=7.7 Hz, 2H), 2.69-2.65 (m, 2H), 2.53-2.46 (m, 4H), 2.46-2.41 (m, 2H), 2.38 (t, J=5.7 Hz, 4H), 2.30 (q, J=6.1, 5.7 Hz, 4H), 2.16 (d, J=5.3 Hz, 2H), 1.64-1.53 (m, 2H), 1.49 (t, J=6.2 Hz, 2H), 1.80 (p, J=7.7 Hz, 2H), 1.65 (d, J=7.1 Hz, 2H). ¹³C NMR (101 MHz, CDCl₃): δ 137.19, 131.40, 130.87, 129.67, 128.55, 127.45, 127.31, 127.22, 126.50, 125.76, 124.97, 124.79, 124.77, 124.59, 123.55, 54.69, 54.37, 52.73, 51.32, 49.87, 49.34, 48.57, 47.75, 47.67, 33.50, 30.07, 28.67, 26.49, 26.21. MS (ESI+): m/z calcd. for C₃₀H₄₀N₄: 456, found: 457 [M+H⁺].

Once prepared, 8.3 was either reacted with NiCl₂ (1:1) in ethanol yielding a fine powder of complex 8 or soaked onto a carbon support (MWCNT as a model for the catalyst support layer in a GDE) in ethanol prior to reaction with NiCl₂.

### Demonstration of Enhanced Current Density for CO₂ Reduction to CO on GDE Using a Mn Electrocatalyst

Experiments using complex 1 were carried out to test the principle of CO₂ reduction on both a glass carbon electrode (GCE) and a gas diffusion electrode (GDE). Experiments were initially carried out at ˜pH 8 (1 M KHCO₃ bulk solution) and GDEs were compared to a standard GCE. The GCE was prepared by depositing the same catalyst ink as used for the GDE in the manner previously described. In these experiments the GCE was placed into an Ar or CO₂ purged solution whilst the GDE system was tested under a constant Ar of CO₂ flow of 10 ml min⁻¹ to the back side of the gas diffusion layer in the GDE. A schematic of the GDE is shown in FIG. 2.

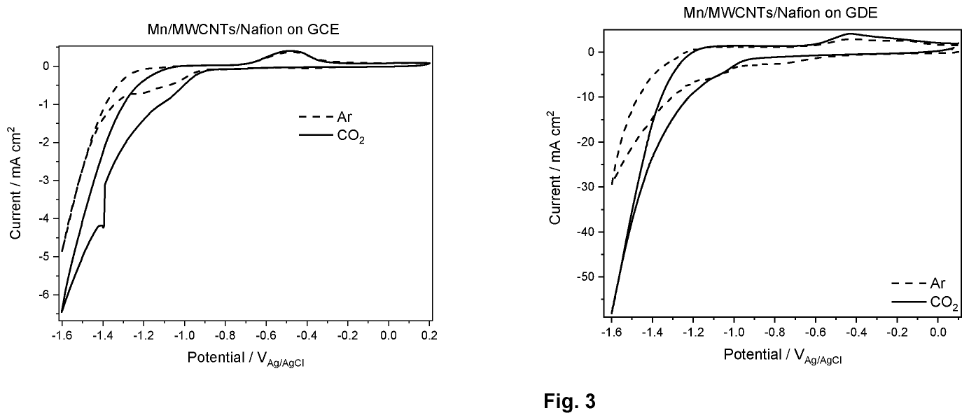

Cyclic voltamogramms were recorded at 50 mV s⁻¹. FIG. 3 shows the CV's of catalyst 1 on either a GCE (left hand graph) or GDE (right hand graph) at 50 mV s⁻¹, pH 8 under either Ar or CO₂. Note the greatly increased current density for the GDE. Both systems showed reductions around −1.1 and −1.25 V leading to the formation of the active catalyst [Mn(bpy)(CO)₃]. Under CO₂, enhanced current densities were observed at negative potentials indicating that CO₂ reduction is occurring. The current density under CO₂ for the Mn GDE was approximately 9 times greater indicating a very large increase in activity for CO₂ reduction. This difference in activity is only in part due to changing electroactive content (approximately twice increased on the GDE), as assessed by integration of the Mn feature at −0.4 V under Ar. It was concluded that even during a cyclic voltammetry measurement where CO₂ concentration depletion is minimised, the enhanced CO₂ concentration at the catalyst/electrolyte/gas interface of the GDE increases activity.

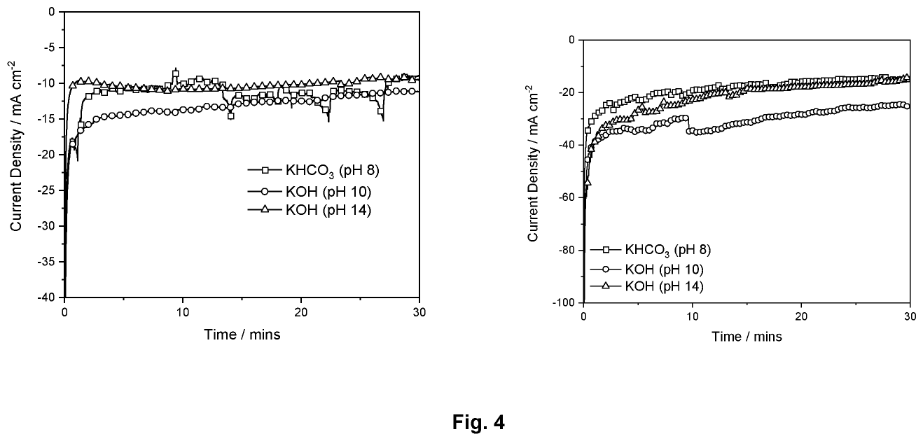

Experiments were carried out using catalyst 1 at a constant potential (versus Ag/AgCl) using 3 different electrolytes, KHCO₃ 1 M (pH 8), KOH adjusted 1M KHCO₃ (pH 10) and 1 M KOH (pH 14). The results are shown in FIG. 4, which shows catalyst 1 on a Elat 1400 GDE at a range of pH's under CO₂ (10 ml min⁻¹) at −1.35 V (left hand graph) and −1.5 V (right hand graph). Currents under CO₂ were not strongly dependent upon pH in the region studied. A high current density was observed at all pHs under CO₂ using the GDE. The observation that even at high pH (14) CO₂ reduction can occur using molecular Mn catalysts such as 1 is surprising given their well-documented need for a Bronsted acid source. CO₂ reduction was confirmed at this pH in prolonged electrolysis experiments with gas detection (see Table 1 below).

### Tests of GDE Support Material/Electrode Preparation Methods

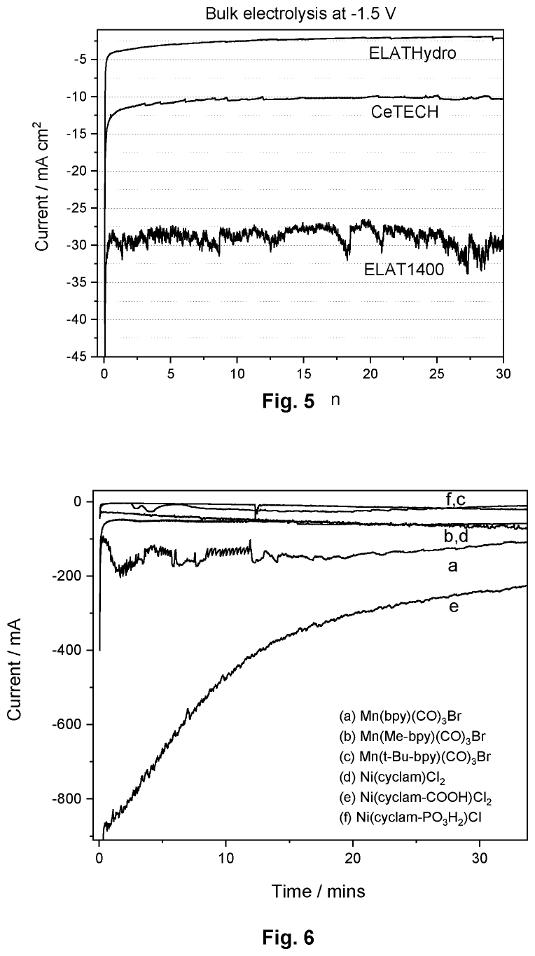

Experiments carried out using catalyst 1 deposited as described above on a range of GDE support materials were made and results for those materials that avoided rapid flooding are summarised in FIG. 5 (which shows results for cataylst 1 on different GDE supports under CO₂ (10 ml min⁻¹) at −1.5 V, 1 M KOH. Throughout the Elat400 was found to be able to provide the most stable behaviour and reasonable current density under CO₂.

### Screen of Catalysts 1-7 on GDE for CO₂ Reduction Activity at pH 14

A series of short (30 minute) experiments were carried out to test the catalysts prepared on GDE in the manner described above. Experiments were carried out at pH 14 (1 M KOH) to test if all catalysts would work under these conditions. The results are summarised in Table 1 and in FIG. 6, which shows examples of chronoamperometry data for complexes 1 -6 using a GDE support under CO₂ (10 ml min⁻¹) at −1.5 V, 1 M KOH.

Results for complex 1 on a GDE can also be compared to the past studies on a GCE. On the GDE at −1.5 V a stable current density of ˜30 mA cm⁻² was achieved at pH 14 with a CO:H₂ ratio of 1.95. In the past study on the GCE at pH 7 at −1.5 V an average current density of 4.38 mA cm⁻² was achieved and a CO:H₂ of 0.2. Although caution should be used when interpreting data from different pHs, these results are in-line with the CV studies that show a large increase in activity for CO₂ reduction using a GDE.

Complex 6 displays the highest currents under CO₂ and also shows very high selectivities towards CO production. Complex 6 was consistently the most active for CO₂ reduction.

TABLE 1

| | Rate H₂ | Rate CO | Selectivity |
|---|---|---|---|
| Experiment | μmol/hour | μmol/hour | CO:H₂ |
| 1 Mn(bpy)(CO)₃Br | | | |
| −1.35 V | 7.40 | 11.45 | 1.355 |
| −1.5 V | 219.93 | 362.41 | 1.95 |
| −1.6 V | 248.24 | 408.78 | 2.57 |
| 2 Mn(Me-bpy)(CO)₃Br | | | |
| −1.35 V | 11.77 | 2.04 | 1.12 |
| 3 Mn(tbu-bpy)(CO)₃Br | | | |
| −1.35 V | 0.21 | 0.34 | 3.37 |
| −1.5 V | 88.86 | 46.98 | 0.92 |
| 4 Mn(COOH-bpy)(CO)₃Br | | | |
| −1.35 V | 117.68 | 28.04 | 0.4 |
| 5 Ni(cyclam)Cl₂ | | | |
| −1.35 V | 0.78 | 1.37 | 3.57 |
| −1.5 V | 31.06 | 344.59 | 11 |
| −1.6 V | 301.97 | 126.16 | 0.5 |
| 6 Ni(cyclam-COOH)Cl₂ | | | |
| −1.35 V | 1.28 | 28.25 | 14.8 |
| −1.5 V | 88.77 | 650.21 | 7.3 |
| 7 Ni(cyclam-PO₃H₂)Cl | | | |
| −1.35 V | 1.11 | 0.74 | 4.5 |
| −1.5 V | 159.97 | 37.57 | 0.515 |

### Role of pH for Catalyst 6 pH 3 and 14

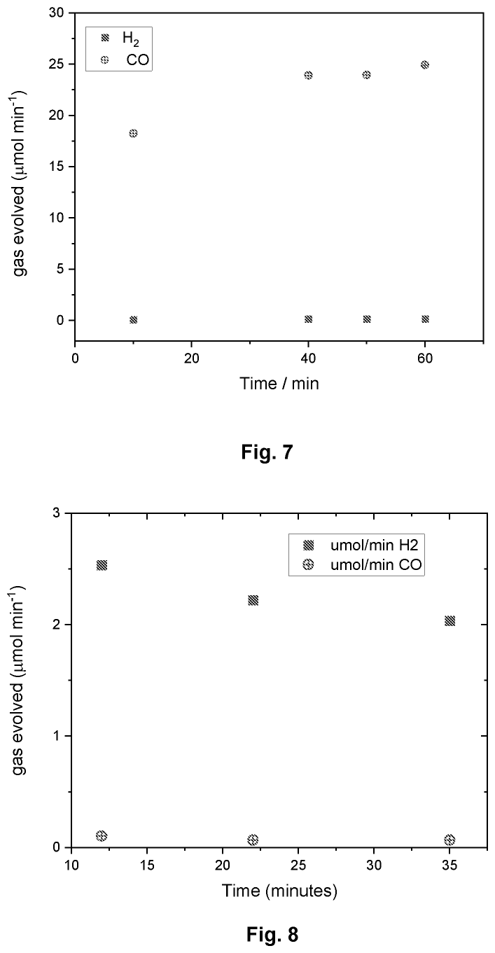

Catalyst 6 was tested initially at pH 14 (see Table 1 above) and achieved the highest current densities and very good selectivity for CO₂ reduction to CO (vs. H₂ evolution, ratios 14.8-7.3:1). In solution, catalyst 6 also works at pH>2, although selectivity is decreased slightly. Therefore experiments were carried out at pH 3 (1 M KCl, HCl adjusted). FIG. 7 shows gas evolved by a GDE coated with 6 at −1.45 V at pH 3 under CO₂. A surprisingly high selectivity for CO₂ reduction to CO was achieved (>100:1) at −1.45 V, as shown in FIG. 7 at pH 3. The higher selectivity towards CO production at pH 3 than at pH 14 is surprising. It might be rationalised by the ability of this catalyst to use the internal —CO₂H group to accelerate CO₂ reduction, potentially in solution activity was [CO₂] limited. FIG. 8 shows gas evolved by a GDE coated with catalyst 6 at −1.45 V at pH 1 under CO₂. Experiments at pH 1 show some CO production (as shown in FIG. 8) but selectivity of CO₂ reduction to CO is lost and H₂ evolution dominates. The pKa of the Ni^{I}—H is thought to be ˜2 and dropping to a pH below this appears to be the cause of the sudden increase in H₂ production and selectivity.

### Testing of Complex 8

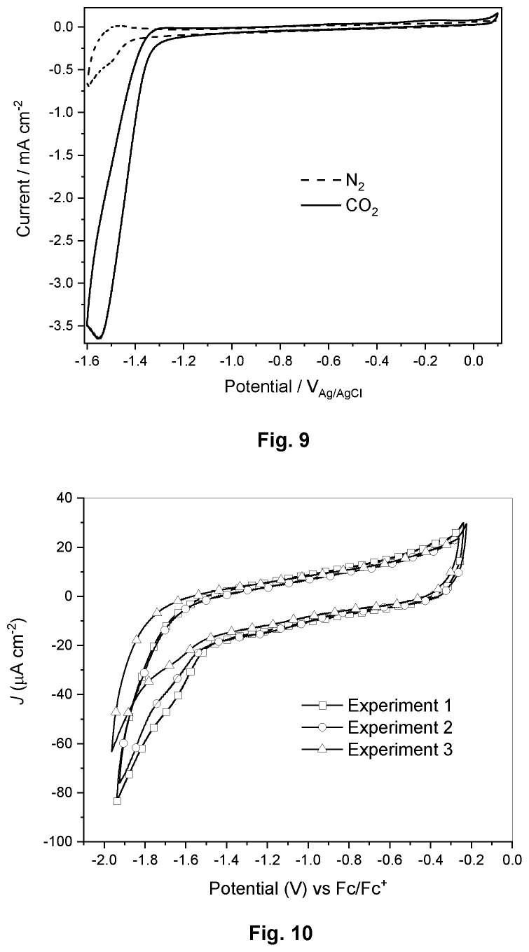

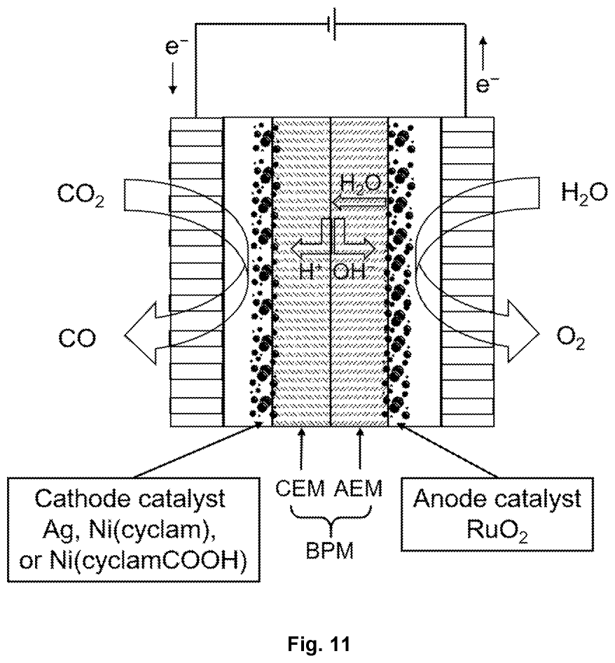

Experiments with complex 8 in solution confirmed its catalytic activity (CH₃CN/H₂O mixtures are used to help with the identification of the Ni^{II/I} couple), FIG. 9. FIG. 9 shows CVs of 1 mM [Ni(cyclam-pyrene)]²⁺ in 0.1 M TBAPF₆ in MeCN and 10% water at GC electrode at 100 mVs⁻¹. This is clearly observed under N₂ and under CO₂ we see a very large increase in current indicating that the catalyst remains active. To test if the catalyst adheres to carbon supports it was soaked onto a GCE which was then washed in ethanol thoroughly and dried. CVs show the presence of complex 8, FIG. 10. FIG. 10 shows CV comparisons of [Ni(cyclam-pyrene)]2+ immobilised on a GCE at 100 mV s−1 under CO₂. Each CV experiment was carried out in a new electrolyte solution of 0.1 M TBA PF6 in MeCN with 10% water.

The electrode is then removed from the electrolyte, washed again with ethanol and the CV checked. This was repeated once more and in all 3 cases the complex 8 was shown to be retained on the electrode surface confirming that it does not detach in the electrolyte or during washing.

### Zero-Gap Electrochemical Cells—Further Testing of Complexes 6 and 7

Using the equipment and methods described above, the performance of catalysts 6 and 7 were studied in the zero-gap cell configuration comprising a bipolar membrane (BPM) as shown schematically in FIG. 11. This configuration leads to a low pH (i.e. acidic) environment at the cathode which has been known to cause poor selectivity for CO production over H₂ using conventional catalysts known in the art. Such a low pH would circumvent the CO₂ loss as carbonates which occurs under alkaline conditions, as discussed above.

### Materials

The following materials were used in the zero-gap electrochemical cell experiments described herein. Milli-Q water (18.2 MΩ) was used throughout. CO₂ was purchased from BOC at CP grade or higher. Other reagents were used as received: Nafion N117 solution ˜5% in a mixture of lower aliphatic alcohols and water (Sigma Aldrich), Isopropyl alcohol (Sigma Aldrich), Fumasep FBM bipolar membrane (BPM) (FuelCellStore), carbon paper Sigracet 39 BB non-woven carbon paper with thickness of 315 um and Microporous Layer and 5 wt % PTFE treatment (FuelCellStore), RuO₂ nanoparticles with particle size of around 5-10 nm (FuelCellStore), Ag nanoparticles with particle size of around 5-10 nm (Sigma Aldrich). Ni(cyclam) and Ni(cyclamCOOH) were synthesised as described above.

### Fabrication of Gas Diffusion Electrodes

The catalysts were deposited onto Sigracet 39 BB carbon paper substrates by spray coating (Harder & Steenbeck Evolution with a N₂ stream) from a suspension. For RuO₂ anode catalyst a loading of 1 mg cm⁻² was obtained by adding 9 mg of the nanoparticles to 1 mL H₂O and 1 mL isopropyl alcohol and 80 μL of 5% Nafion solution. The solution was sonicated for 30 min and then spray coated onto a 9 cm² carbon substrate placed on a hot plate at 95° C. For the comparative Ag cathode catalyst a loading of 1 mg cm⁻² was obtained by adding 5 mg of the Ag nanoparticles to 1 mL H₂O and 1 mL isopropyl alcohol and 80 μL of 5% Nafion solution. The solution was sonicated for 30 min and then spray coated onto a 5 cm² carbon substrate placed on a hot plate at 95° C. For molecular catalysts 6 and 7, a catalyst loading of 1 mg cm⁻² was obtained by adding 5 mg of the catalyst to 1 mL H₂O and 1 mL isopropyl alcohol and 80 μL of 5% Nafion solution. After fully dissolving the catalysts, the solution was sonicated for 1 min and then spray coated onto a 5 cm² carbon substrate placed on a hot plate at 30° C.

### Electrochemistry

Electrochemical measurements were carried out using a Biologic SP-200 potentiostat. The membrane-electrode assembly shown in FIG. 11 was constructed by sandwiching the bipolar membrane (BPM) between the anode and cathode layers (with the cation exchange layer (CEM) towards the cathode and the anion exchange layer (AEM) towards the anode, as shown in FIG. 11) and ‘cold pressing’ the layers together between the bipolar plates of the electrolyser cell. The membrane-electrode assembly was assembled in a 5 cm² electrolyser from Dioxide Materials. The electrolyser consisted of a titanium anode plate with an active area of 9 cm² and a stainless-steel cathode plate with an active area of 5 cm², separated by Teflon spacers. The membrane-electrode assembly is sandwiched between these plates to provide a zero-gap assembly to which gas is flowed to the cathode and electrolyte is flowed to the anode. The cell was assembled with a torque of 3 Nm.

CO₂ was flowed at 20 ml/min, first passing through an H₂O bubbler at room temperature to humidify the gas before entering the electrolyser. Anolyte (milli-Q H₂O) was flowed across the anode at 15 ml/min. Electrochemistry was performed in a 2-electrode configuration under constant current conditions. Before measurement, the cell was pre-conditioned at open circuit, with CO₂ and anolyte flowing, for at least 30 min until the cell resistance was stabilized.

For comparison of activity at different current densities, the measurement was conducted in order of increasing currents on the same cell setup, 10 min at each current with a 30 min pause in between each segment with CO₂ and anolyte kept flowing. The faradaic efficiency reported is the initial value for each segment. The experiment was conducted in triplicate, and the error bars correspond to 1 standard deviation.

### Product Detection

Gaseous product in the gas outlet stream was measured by gas chromatography using a Varian CP-4900 MicroGC with a Molsieve 5 Å column with Ar carrier gas for H₂ and CO detection.

### Characterization

Scanning electron microscopy (SEM) and Energy dispersive X-ray spectroscopy (EDX) were conducted with a Hitachi S4800. X-ray Photoelectron Spectroscopy (XPS) measurements were performed on Thermo Scientific K-Alpha X-ray Photoelectron Spectrometer using Al K_{α} source on a 400×400 μm² area. The survey scans were performed in 0-1200 eV range at 200 eV pass energy and the high-resolution scans were performed in the respective range at 60 eV pass energy. The obtained spectra were analysed using CasaXPS software (version 2.3.17). The spectra were calibrated using F 1 s (689.67 eV) or N 1 s (400.5 eV).

### Results

Chronopotentiometry was conducted at various current densities (from 2.5 to 100 mA/cm²) and benchmarked against a commercial Ag nanoparticle catalyst GDE. The cells were operated with the CO₂ reduction catalysts in direct contact with the CEL of a commercial Fumasep BPM.

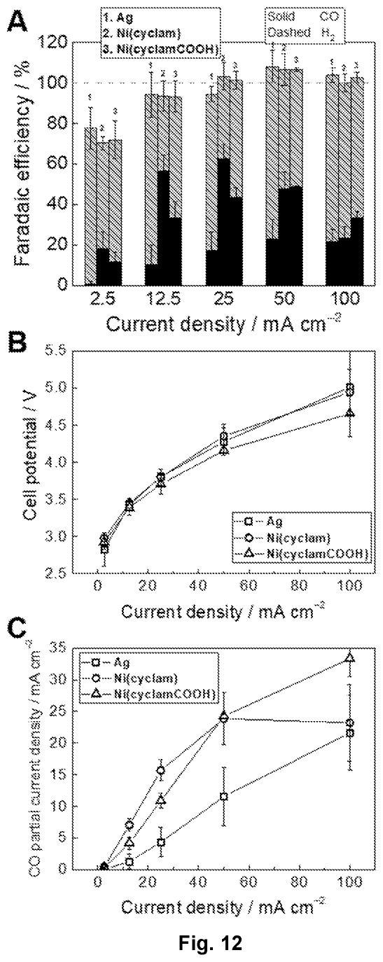

The Faradaic efficiency and full cell voltages are shown in FIGS. 12A and 12B. When Ag was the cathode catalyst H₂ was the dominant product at all current densities in-line with past studies of Ag with an acidic electrolyte. The Faradaic efficiency for CO on Ag was very low (10±9%) at 12.5 mA/cm² and it increased slightly with current density, reaching a maximum of 23±9% at 50 mA/cm². The increase in CO selectivity with current density can be explained by the expected increase in the local pH at the electrode surface. The CO₂ reduction reaction (and H₂ evolution) consumes protons, therefore the proton activity in the boundary layer of the electrolyte is lowered, decreasing H₂ evolution.

The molecular catalysts 6 and 7 achieved significantly higher CO Faradaic efficiency across the current range studied. The maximum CO Faradaic efficiency reached was 63%±7 at 25 mA/cm² for complex 6 and 48%±1 at 50 mA/cm² for complex 7.

The cell voltages were similar (˜2.8-5.0 V) across all three cathode catalysts.

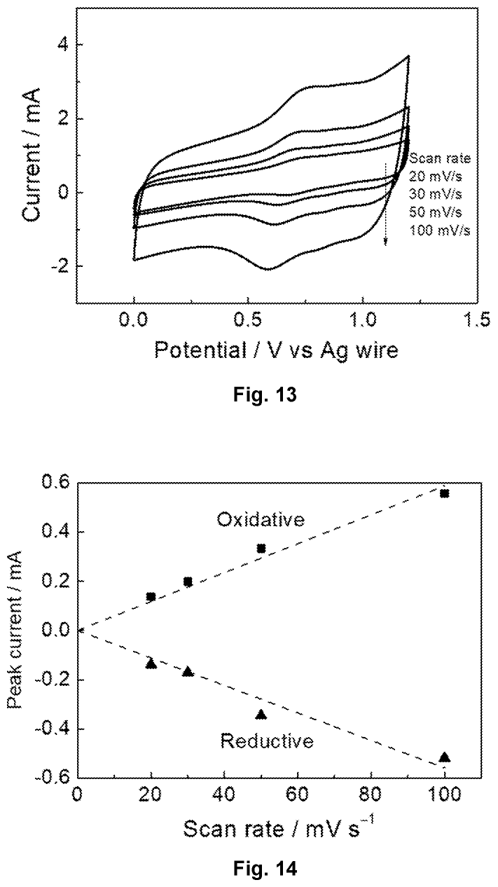

The CO partial current density (FIG. 12C) shows that the activity of the molecular catalysts levelled off, especially for complex 6. To estimate the turnover frequency (TOF), the electroactive coverage of complex 6 on the GDE by cyclic voltammetry in acetonitrile (see FIGS. 13 and 14) was measured. Using the Ni^{3+/2+} couple which lies more positive of the onset for CO₂ reduction and H₂ evolution, the electroactive coverage was estimated as 1.5±0.2×10⁻⁸ mol cm⁻² leading to a maximum TOF of 8±2 s⁻¹ calculated from the highest CO partial current density of 23.2 mA cm⁻².

Thus complexes 6 and 7 demonstrate improved selectivity for CO₂ reduction to CO compared to metallic Ag catalysts up to 100 mA/cm² in the low pH local environment (i.e. acidic) of the cathode in the zero-gap CO₂ electrolyser configuration described herein. The present invention may therefore provide an electrochemical cell and a method of electrochemical reduction of carbon dioxide which is selective for CO production at low pH, which avoids the build-up of carbonate in the cell and which may be scalable to allow implementation on an industrial scale. This would enable the production of significant quantities of carbon monoxide from a waste gas stream of CO₂ and therefore reduce the environmental impact of chemical feedstock production.

In summary, the present invention provides a gas diffusion electrode for the electrochemical reduction of carbon dioxide. The gas diffusion electrode comprises a gas diffusion layer and a nickel or manganese-based molecular catalyst comprising an organic ligand. The gas diffusion electrode may provide a selective electrochemical reduction of carbon dioxide to carbon monoxide, in preference to hydrogen, and may be useful for the production of carbon monoxide from industrial waste gas streams of carbon dioxide. An electrochemical cell comprising the gas diffusion electrode, a nickel-based molecular catalyst and a method of electrochemical reduction of carbon dioxide are also provided.

Although a few preferred embodiments have been shown and described, it will be appreciated by those skilled in the art that various changes and modifications might be made without departing from the scope of the invention, as defined in the appended claims.

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention. Typically, when referring to compositions, a composition consisting essentially of a set of components will comprise less than 5% by weight, typically less than 3% by weight, more typically less than 1% by weight of non-specified components.

The term “consisting of” or “consists of” means including the components specified but excluding addition of other components.

Whenever appropriate, depending upon the context, the use of the term “comprises” or “comprising” may also be taken to encompass or include the meaning “consists essentially of” or “consisting essentially of”, and may also be taken to include the meaning “consists of” or “consisting of”.

For the avoidance of doubt, wherein amounts of components in a composition are described in wt %, this means the weight percentage of the specified component in relation to the whole composition referred to.

The optional features set out herein may be used either individually or in combination with each other where appropriate and particularly in the combinations as set out in the accompanying claims. The optional features for each aspect or exemplary embodiment of the invention as set out herein are also to be read as applicable to any other aspect or exemplary embodiments of the invention, where appropriate. In other words, the skilled person reading this specification should consider the optional features for each exemplary embodiment of the invention as interchangeable and combinable between different exemplary embodiments.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, and drawings), and/or all of the steps of any method or process so disclosed, may be combined in any combination, except combinations where at least some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, and drawings), or to any novel one, or any novel combination, of the steps of any method or process so disclosed.

1. An electrochemical cell comprising a cathode, an anode, an ion-exchange membrane separating the anode and cathode, and a gas supply for providing carbon dioxide gas to the cathode; wherein the cathode is provided by a gas diffusion electrode comprising a gas diffusion layer and a molecular catalyst, wherein the molecular catalyst comprises a metal and an organic ligand; wherein the metal is selected from manganese and/or nickel.

2. The electrochemical cell according to claim 1, wherein the organic ligand is a nitrogen-containing heterocycle.

3. The electrochemical cell according to claim 1, wherein the molecular catalyst has a formula which comprises MLₐX_{b}, wherein M is the metal selected from manganese and nickel, L is the organic ligand and X is an anion, wherein a is an integer from 1 to 3 and b is an integer from 0 to 4.

4. The electrochemical cell according to claim 1, wherein the molecular catalyst is a manganese molecular catalyst comprising at least one nitrogen-containing heterocycle.

5. The electrochemical cell according to claim 4, wherein the manganese molecular catalyst has the formula Mn(L)(CO)_{c}X_{b}, wherein L is a nitrogen-containing heterocycle and X is an anion; wherein c is an integer from 1 to 4 and b is an integer from 0 to 4.

6. The electrochemical cell according to claim 5, wherein the nitrogen-containing heterocycle is a 2,2′-bipyridyl ligand.

7. The electrochemical cell according to claim 1, wherein the molecular catalyst is a nickel molecular catalyst comprising an azamacrocycle.

8. The electrochemical cell according to claim 7, wherein the azamacrocycle is a cyclam.

9. The electrochemical cell according to claim 8, wherein the nickel molecular catalyst has the formula (XII): 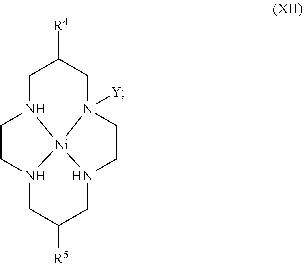
wherein R⁴ and R⁵ are each independently selected from H, hydroxy, amino, thiol, chloro, fluoro, CF₃, CHF₂, CH₂F, a C₁-C₈ alkyl group, optionally forming a ring, a C₁-C₈ alkenyl group, an aryl group, a heteroaryl group, a C₁-C₈ alkoxy group, a C₁-C₈ alkylamino group, a C₁-C₈ alkylthio group, groups; or a (CO)OR⁶ group or a (CO)NHR⁶ group, wherein R⁶ is selected from H, a C₁-C₈ alkyl group, optionally forming a ring, a C₁-C₈ alkenyl group or an aryl group;
wherein Y is selected from H, a (CH₂)ₙZ group, wherein n is an integer from 1 to 6 and Z is a polar group selected from —PO₃H₂, —CO₂H, —Si(OH)₃, —SH, NH₂ and OH.

10. The electrochemical cell according to claim 8, wherein the nickel molecular catalyst has the formula (XII): 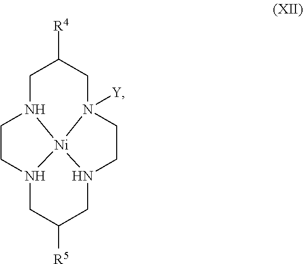
wherein R⁴ and R⁵ are each independently selected from H, hydroxy, amino, thiol, chloro, fluoro, CF₃, CHF₂, CH₂F, a C₁-C₈ alkyl group, optionally forming a ring, a C₁-C₈ alkenyl group, an aryl group, a heteroaryl group, a C₁-C₈ alkoxy group, a C₁-C₈ alkylamino group, a C₁-C₈ alkylthio group, groups; or a (CO)OR⁶ group or a (CO)NHR⁶ group, wherein R⁶ is selected from H, a C₁-C₈ alkyl group, optionally forming a ring, a C₁-C₈ alkenyl group or an aryl group;
wherein Y is selected from H, a (CH₂)ₙZ group, wherein n is an integer from 1 to 6 and Z is a polar group selected from —PO₃H₂, —CO₂H, —Si(OH)₃, —SH, NH₂ and OH.

11. The electrochemical cell according to claim 1, wherein the gas diffusion layer is a porous carbon material.

12. The electrochemical cell according to claim 1, wherein the molecular catalyst is adhered to the gas diffusion layer by a composition comprising a fluorocarbon polymer.

13. The electrochemical cell according to claim 1, wherein the gas diffusion layer has an electro-active side comprising the molecular catalyst and a back side, wherein the gas supply is directed to the back side of the gas diffusion layer.

14. The electrochemical cell according to claim 13, comprising a source of an aqueous catholyte which is directed to the electro-active side of the gas diffusion layer of the gas diffusion electrode.

15. The electrochemical cell according to claim 1, wherein the molecular catalyst of the gas diffusion electrode is arranged in direct contact with the ion-exchange membrane.

16. The electrochemical cell according to claim 15, wherein the ion-exchange membrane is a bipolar membrane comprising a cation-exchange membrane and an anion-exchange membrane; wherein the molecular catalyst is arranged in direct contact with the cation-exchange membrane and the anode is arranged in direct contact with the anion-exchange membrane.

17. A gas diffusion electrode comprising a gas diffusion layer and a molecular catalyst, wherein the molecular catalyst is:
a manganese molecular catalyst having the formula Mn(L)(CO)_{c}X_{b}, wherein L is a nitrogen-containing heterocycle and X is an anion; wherein c is an integer from 1 to 4 and b is an integer from 0 to 4; or
a nickel molecular catalyst having the formula (XII): 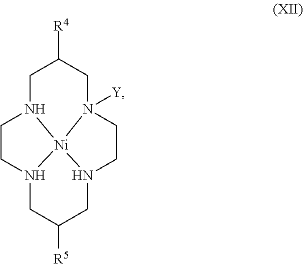
wherein R⁴ and R⁵ are each independently selected from H, hydroxy, amino, thiol, chloro, fluoro, CF₃, CHF₂, CH₂F, a C₁-C₈ alkyl group, optionally forming a ring, a C₁-C₈ alkenyl group, an aryl group, a heteroaryl group, a C₁-C₈ alkoxy group, a C₁-C₈ alkylamino group, a C₁-C₈ alkylthio group, groups; or a (CO)OR⁶ group or a (CO)NHR⁶ group, wherein R⁶ is selected from H, a C₁-C₈ alkyl group, optionally forming a ring, a C₁-C₈ alkenyl group or an aryl group;
wherein Y is selected from H, a (CH₂)ₙZ group, wherein n is an integer from 1 to 6 and Z is a polar group selected from —PO₃H₂, —CO₂H, —Si(OH)₃, —SH, NH₂ and OH.

18. (canceled)

19. A method of electrochemical reduction of carbon dioxide, the method comprising:
a) providing a cathode and an anode, wherein the cathode is a gas diffusion electrode comprising a molecular catalyst, wherein the molecular catalyst comprises a metal and an organic ligand; wherein the metal is selected from manganese and/or nickel;
b) contacting the carbon dioxide in gaseous form with the molecular catalyst, optionally in the presence of water; and
c) applying an electrical potential between the cathode and the anode, thereby electrochemically reducing the carbon dioxide to gaseous products including carbon monoxide.

20. The method according to claim 19, wherein the gas diffusion electrode provided in step a) comprises a gas diffusion layer and a molecular catalyst. wherein the molecular catalyst is:
a manganese molecular catalyst having the formula Mn(L)(CO)_{c}X_{b}, wherein L is a nitrogen-containing heterocycle and X is an anion; wherein c is an integer from 1 to 4 and b is an integer from 0 to 4; or
a nickel molecular catalyst having the formula (XII): 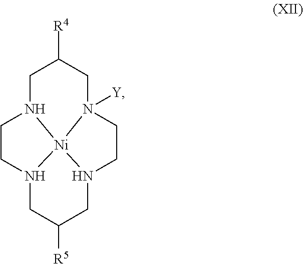
wherein R⁴ and R⁵ are each independently selected from H, hydroxy, amino, thiol, chloro, fluoro, CF₃, CHF₂, CH₂F, a C₁-C₈ alkyl group, optionally forming a ring, a C₁-C₈ alkenyl group, an aryl group, a heteroaryl group, a C₁-C₈ alkoxy group, a C₁-C₈ alkylamino group, a C₁-C₈ alkylthio group, groups; or a (CO)OR⁶ group or a (CO)NHR⁶ group, wherein R⁶ is selected from H, a C₁-C₈ alkyl group, optionally forming a ring, a C₁-C₈ alkenyl group or an aryl group;
wherein Y is selected from H, a (CH₂)ₙZ group, wherein n is an integer from 1 to 6 and Z is a polar group selected from —PO₃H₂, —CO₂H, —Si(OH)₃, —SH, NH₂ and OH.

21. The method according to claim 19, wherein steps b) and c) take place at a pH of less than 6.
